(19) United States
(12) Patent Application Publication
(10) Pub. No.: US 2010/0238930 A1
(43) Pub. Date: Sep. 23, 2010

(54) ROUTER AND METHOD OF FORWARDING IPV6 PACKETS

(75) Inventor: ZHE SHAN, Shanghai (CN)

Correspondence Address: Altis Law Group, Inc.;ATTN: Steven Reiss, 288 SOUTH MAYO AVENUE, CITY OF INDUSTRY, CA, 91789, US

(73) Assignees: AMBIT MICROSYSTEMS (SHANGHAI) LTD., SHANGHAI (CN); HON HAI PRECISION INDUSTRY CO., LTD., Tu-Cheng (TW)

(21) Appl. No.: 12/479,826

(22) Filed: Jun. 7, 2009

(30) Foreign Application Priority Data
Mar. 19, 2009 (CN) 200910300950.5

(51) Int. Cl. H04L 12/56

(52) U.S. Cl. 370/392

(57) ABSTRACT

A method of a router to process IPv6 packets includes: receiving a packet and determining whether the packet is IPv6 packet; determining the source of the IPv6 packet according to the control information of the IPv6 packet if the packet is IPv6 packet; modifying the control information of the IPv6 packet according to the source of the IPv6 packet, and transmitting the IPv6 packet directly to a wide area network (WAN) or a local area network (LAN) according to the modified control information of the IPv6 packet.

### BACKGROUND

1. Technical Field

The present disclosure relates to network communications, and more particularly to a router and method of forwarding IPv6 packets.

2. Description of Related Art

The IPv4 network communication protocol is widely used in traditional Internet protocol (IP) networks. With the development of the Internet, shortcomings of the IPv4 network communication protocol have emerged. The most serious and urgent shortcomings are that IP addresses will soon be all allocated and routing tables in current routers are excessively huge, which directly brings a next generation Internet protocol, namely IPv6 network communication protocol, to birth.

However, the basic architecture of IPv4 network is still implemented widely and the number of IPv4 related apparatuses is numerous. For example, many routers can only communicate with other network devices with the IPv4 protocol. Therefore, a heretofore unaddressed need exists for routers that can overcome the limitations existing in using the IPv6 protocol.

### BRIEF DESCRIPTION OF THE DRAWINGS

The details of the disclosure, both as to its structure and operation, can best be understood by referring to the accompanying drawings, in which like reference numbers and designations refer to like elements.

FIG. 1 is an application environment and a schematic diagram of functional modules of one embodiment of a router of the present disclosure; and

FIG. 2 is a flowchart of a method of forwarding IPv6 packets of the router of FIG. 1 in accordance with the present disclosure.

### DETAILED DESCRIPTION

All of the processes described may be embodied in, and fully automated via, software code modules executed by one or more general purpose computers or processors. The code modules may be stored in any type of computer-readable medium or other storage device. Some or all of the methods may alternatively be embodied in specialized computer hardware or communication apparatus.

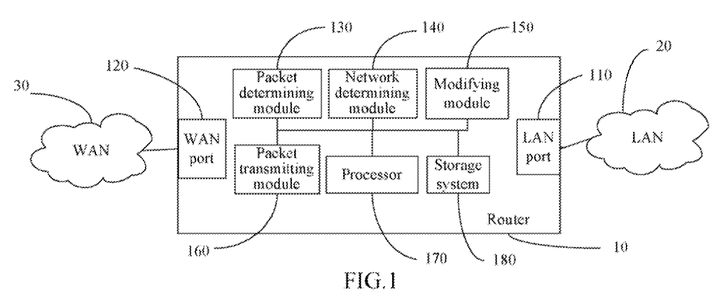

FIG. 1 is an application environment and a schematic diagram of functional modules of one embodiment of a router 10 of the present disclosure. In one embodiment, the router 10 includes at least one local area network (LAN) port 110 and at least one wide area network (WAN) port 120. The router 10 is connected between a LAN 20 and a WAN 30 by way of the LAN port 110 and the WAN port 120, respectively. The router 10 is operable to forward IPv4 and/or IPv6 packets between a local area network (LAN) and a wide area network (WAN) communicating with the LAN port 110 and the WAN port 120, respectively.

In one embodiment, the router 10 includes a packet determining module 130, a network determining module 140, a modifying module 150, a packet transmitting module 160, at least one processor 170, and a storage system 180. The modules 130-160 may include one or more computerized instructions that are stored in the storage system 180 and are executed by the at least one processor 170.

The packet determining module 130 is operable to receive a packet from the LAN 20 by way of the LAN port 110 or from the WAN 30 by way of the WAN port 120 and to determine a type of the received packet. The type of the received packet includes an IPv4 type, an Address Resolution Protocol (ARP) type, an IPv6 type, for example. In the embodiment, the received packet includes a type field indicating the type of the received packet. In addition, the received packet comprises control information where the control information of the received packet is a data structure of skb->dev, which is defined by Internet protocol and stored in the storage system 180. In one embodiment, the packet determining module 130 determines the type of the received packet according to the type field. Typically, the router 10 can process the received packet upon the condition that the type of the received packet is IPv4 or ARP in a usual manner. For example, if the received packet is an IPv4 packet, the router 10 translates an IP address of the IPv4 packet and transmits the IPv4 packet. If a packet is an IPv6 packet, then it is processed as detailed below.

The network determining module 140 is operable to determine a source port of the received packet according to the control information of the received packet upon the condition that the received packet is an IPv6 packet. In one embodiment, the packet determining module 130 determines the source port of the received IPv6 packet according to the control information of the received IPv6 packet. In this embodiment, the control information of the received IPv6 packet comprises equipment information about a device from which the IPv6 packet is received. It may be understood that the equipment information includes the name of the port, and/or the state of the port, for example. The network determining module 140 determines that the source port of the received IPv6 packet is the LAN port 110 if the control information of the received packet comprises the equipment information of the LAN port 110. The network determining module 140 determines that the source port of the received IPv6 packet is the WAN port 120 if the control information of the received packet is the equipment information of the WAN port 120.

The modifying module 150 is operable to modify the control information of the received IPv6 packet according to the source port thereof. In one embodiment, the modifying module 150 modifies the control information of the received IPv6 packet to be the equipment information of the WAN port 120 upon the condition that the source port of the received IPv6 packet is the LAN port 110. When the source port of the received IPv6 packet is the WAN port 120 then the modifying module 150 modifies the control information of the received IPv6 packet to be the equipment information of the LAN port 110.

The packet transmitting module 160 is operable to transmit the received IPv6 packet directly by way of another one of the LAN port 110 and the WAN port 120 according to the modified control information of the received IPv6 packet. In one embodiment, if the modified control information of the received IPv6 packet is the equipment information of the LAN port 110, then the packet transmitting module 160 transmits the received IPv6 packet directly to the LAN 20 by way of the LAN port 110 by invoking a transmitting function. When the modified control information of the received IPv6 packet is the equipment information of the WAN port 120, then the packet transmitting module 160 transmits the received packet directly to the WAN 30 by way of the WAN port 120 by invoking the transmitting function. In one embodiment, the transmitting function is dev_queue_xmit( ) defined by the Internet protocol.

Besides processing IPv4 packets, the router 10 may process the IPv6 packets by modifying the control information of the received IPv6 packets. Therefore, the router 10 can handle IPv6 traffic in an IPv4 network.

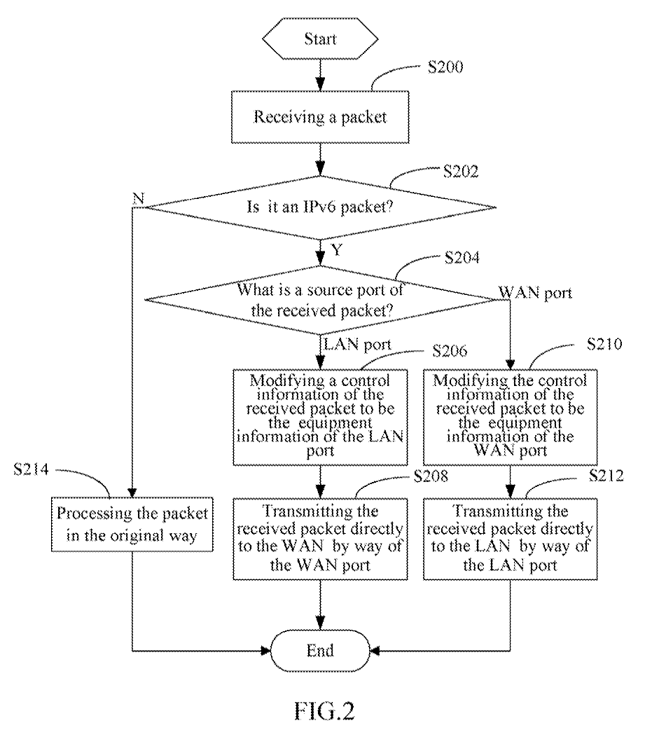

FIG. 2 is a flowchart of a method of forwarding IPv6 packets of the router 10 of FIG. 1 in accordance with the present disclosure. The method may be embodied in the router 10, and is executed by the functional modules such as those of FIG. 1. Depending on the embodiment, additional blocks may be added, others deleted, and the ordering of the blocks may be changed while remaining well within the scope of the disclosure.

In block S200, the packet determining module 130 receives a packet from one of a LAN port 110 and a WAN port 120 of the router 10, wherein the received packet comprises control information corresponding to one of the LAN port 110 and the WAN port 120 from which the packet is received. In one embodiment, the received packet is from the LAN 10 or the WAN 20.

In block S202, the packet determining module 130 determines if the received packet is the IPv6 packet, wherein the received packet comprises a type field indicating type of the received packet. In one embodiment, the step of the packet determining module 130 determines if the received packet is the IPv6 packet according to the type field. The received packet is IPv6 packet if the type field is IPv6, otherwise, the received packet is not the IPv6 packet.

If the packet determining module 130 determines the received packet is an IPv6 packet, then in block S204, the network determining module 140 determines the source port of the received IPv6 packet. In one embodiment, the network determining module 140 determines the source port of the received IPv6 packet according to the control information of the received IPv6 packet. In one embodiment, the network determining module 140 determines that the source port of the received IPv6 packet is the LAN port 110 upon the condition that the control information of the received IPv6 packet is the equipment information of the LAN port 110, and the network determining module 140 determines that the source port of the IPv6 packet is the WAN port 120 upon the condition that the control information of the received IPv6 packet is the equipment information of the WAN port 120.

If the source port of the received IPv6 packet is the LAN port 110, then in block S206, the modifying module 150 modifies the control information of the received IPv6 packet to be the equipment information of the WAN port 120. In one embodiment, the processor 170 gets the equipment information of the WAN port 120 from the storage system 180, then, the modifying module 150 replaces the control information of the received packet with the equipment information of the WAN port 120.

In block S208, the packet transmitting module 160 transmits the received IPv6 packet directly to the WAN 30 by way of the WAN port 120 according to the modified control information of the received IPv6 packet. In one embodiment, the packet transmitting module 160 transmits the packet by invoking the transmitting function.

If the source port of the received IPv6 packet is the WAN port 120, then in block S210, the modifying module 150 modifies the control information of the received IPv6 packet to be the equipment information of the LAN port 110.

In block S212, the packet transmitting module 160 transmits the received packet directly to the LAN 20 by way of the LAN port 110 according to the modified control information of the received packet by invoking the transmitting function.

If the packet determining module 130 finds that the received packet is not an IPv6 packet, but is a kind of packet that the router 10 can process such as an IPv4 packet, an ARP packet, for example, then in block S214, the router 10 processes the packet in the original way. For example, if the received packet is the IPv4 packet, the router 10 changes an IP address of the IPv4 packet, and transmits the IPv4 packet.

The router 10 can conveniently and quickly transmit the packet by way of the packet determining module 130, the network determining module 140, the modifying module 150, and the packet transmitting module 160. The router 10 and the method of forwarding the packet can realize both the IPv4 Protocol and IPv6 Protocol in the same network.

While various embodiments and methods of the present disclosure have been described above, it should be understood that they have been presented by way of example only and not by way of limitation. Thus, the breadth and scope of the present disclosure should not be limited by the above-described exemplary embodiments, but should be defined only in accordance with the following claims and their equivalents.

What is claimed is:

1. A router to forward IPv4 packets and IPv6 packets within a local area network (LAN) port and a wide area network (WAN) port, the router comprising a processor, a memory, and one or more programs, wherein the one or more programs are stored in the memory and operable to be executed by the processor, the programs comprising:
a packet determining module operable to receive a packet from one of the LAN port and the WAN port, and determine if the received packet is an IPv6 packet, wherein the IPv6 packet comprising control information corresponding to said one of the LAN port and the WAN port;
a network determining module operable to determine a source port of the received IPv6 packet according to the control information of the received packet upon the condition that the received packet is the IPv6 packet;
a modifying module operable to modify the control information of the received IPv6 packet according to the source port; and
a packet transmitting module operable to transmit the received IPv6 packet directly by way of another one of the LAN port and the WAN port according to the modified control information of the received IPv6 packet.

2. The router as claimed in claim 1, wherein the control information of the received IPv6 packet comprises a data structure of skb->dev.

3. The router as claimed in claim 1, wherein the modifying module modifies the control information of the received packet to be the equipment information of the WAN port upon the condition that the source port of the received packet is the LAN port.

4. The router as claimed in claim 1, wherein the modifying module modifies the control information of the received packet to be the equipment information of the LAN port upon the condition that the source port of the received packet is the WAN port.

5. The router as claimed in claim 1, wherein the received packet comprises a type field indicating type of the received packet.

6. The router as claimed in claim 1, wherein the packet determining module determines the received packet is the IPv6 packet according to the type field.

7. A method to forward IPv6 packet using a router, comprising:
receiving a packet from one of a local area network (LAN) port and a wide area network (WAN) port of the router;
determining if the received packet is an IPv6 packet, wherein the IPv6 packet comprises control information corresponding to the one of the LAN port and the WAN port from which the packet is received;
determining source port of the received packet according to the control information of the received packet upon the condition that the received packet is the IPv6 packet;
modifying the control information of the received IPv6 packet according to the source port; and
transmitting the received IPv6 packet directly by way of another one of the LAN port and the WAN port according to the modified control information of the received IPv6 packet.

8. The method as claimed in claim 7, wherein the control information of the received IPv6 packet comprise a data structure of skb->dev.

9. The method as claimed in claim 7, wherein the received packet comprises a type field indicating type of the received packet.

10. The method as claimed in claim 9, wherein determining if the received packet is the IPv6 packet is according to the type field of the received packet.

11. The method as claimed in claim 7, wherein determining source port of the received packet comprises:
determining the source port of the received packet is the LAN port if the control information of the received packet is the equipment information of the LAN port.

12. The method as claimed in claim 11, wherein modifying the control information of the received IPv6 packet comprises:
modifying the control information of the received IPv6 packet to be the equipment information of the WAN port upon the condition that the source port of the received IPv6 packet is the LAN port.

13. The method as claimed in claim 7, wherein determining source port of the received IPv6 packet comprises:
determining the source port of the received IPv6 packet is the WAN port if the control information of the received IPv6 packet is the equipment information of the WAN port.

14. The method of claim 13, wherein modifying the control information of the received IPv6 packet comprises:
modifying the control information of the received IPv6 packet to be the equipment information of the LAN port upon the condition that the source port of the received IPv6 packet is the WAN port.
